(19) United States
(12) Patent Application Publication
(10) Pub. No.: US 2014/0099203 A1
(43) Pub. Date: Apr. 10, 2014

(54) MECHANICAL AND OTHER IMPROVEMENTS OF A VERTICAL AXIS WIND TURBINE

(71) Applicant: WIND HARVEST INTERNATIONAL, INC., POINT REYES STATION, CA (US)

(72) Inventors: ROBERT NASSON THOMAS, VENTURA, CA (US); JULIAN RICHARD STILL, SCHAERBEEK (BE); PHILLIPPE PARMENTIER, MARCQ (BE); ALIN-LONUT MUNTEANU, POGOANELE (RO)

(73) Assignee: WIND HARVEST INTERNATIONAL, INC., POINT REYES STATION, CA (US)

(21) Appl. No.: 14/045,542

(22) Filed: Oct. 3, 2013

Related U.S. Application Data
(60) Provisional application No. 61/709,944, filed on Oct. 4, 2012.

(51) Int. Cl. F03D 3/06; B23P 15/04; F03D 3/02

(52) U.S. Cl. CPC F03D 3/064; F03D 3/02; B23P 15/04
USPC 416/1; 416/211; 416/198 R; 29/889.21

(57) ABSTRACT

In an embodiment, a vertical axis wind turbine may be constructed to better survive wear and tear while being more energy efficient. A turbine blade may capture air movement to generate power. A blade arm may hold the turbine blade parallel to a rotating shaft. The blade arm may transmit torque from the turbine blade to the rotating shaft to drive a rotor of an electrical power generator. A moment-free connector may connect the turbine blade to the blade arm to transmit a stress maxima to a structural strongpoint of the turbine blade away from the moment-free connector.

### RELATED APPLICATIONS

This application is the non-provisional application for the provisional application Ser. No. 61/709,944, titled “Mechanical and Other Improvements of a Vertically Axis Turbine”, filed Oct. 4, 2012, which is herein incorporated by reference. This application claims the benefit of and priority to the provisional application Ser. No. 61/709,944.

### FIELD

Example embodiments for processes and apparatuses for a vertical-axis wind turbine are described.

### BACKGROUND

A wind turbine may convert air current, i.e. wind, into electrical power. A wind turbine may capture wind based on the shape of a turbine blade. The wind presses against the turbine blade, causing the turbine blade to rotate around a shaft. The torque from the turbine blade on the shaft may cause the shaft to rotate, driving a magnetic rotor to rotate between a pair of coils, generating an electrical current.

### SUMMARY

This Summary is provided to introduce an example selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to constructing a vertical axis wind turbine to better survive wear and tear while being more energy efficient. A turbine blade may capture air movement to generate power. A blade arm may hold the turbine blade parallel to a rotating shaft. The blade arm may transmit torque from the turbine blade to the rotating shaft to drive a rotor of an electrical power generator. A moment-free connector may connect the turbine blade to the blade arm to transmit a stress maxima to a structural strongpoint of the turbine blade away from the moment-free connector.

### DRAWINGS

In order to describe the manner in which the above-recited and other advantages and features can be obtained, a more particular description is set forth and will be rendered by reference to specific embodiments thereof, which are illustrated, in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, an embodiment of a turbine comparison of vertical axis wind turbine and a horizontal axis wind turbine.

FIG. 2 illustrates, in a block diagram, an embodiment of an aligned vertical axis wind turbine with three or more turbine blades in an upper section of the turbine and a matching number of three or more turbine blades in a lower section of the turbine aligned with the three or more blades in the upper section.

FIGS. 3a-3b illustrate, in block diagrams, an embodiment of a section of the rotating drive shaft where the multiple sections bolt together.

FIGS. 4a-4d illustrate, in block diagrams, an embodiment with multiple views of a moment-free connector where the clamp is a laser-cut steel clamp molded to fit the exact geometric shape of an aero foil of the turbine blade.

FIG. 5a illustrates, in a block diagram, an embodiment of a vertical axis wind turbine with at least an upper level and a lower level/section, and each of these has its own set of two or more turbine blades that are offset with respect to each other.

FIG. 5b illustrates, in a block diagram, an embodiment of a hinged implementation version of a moment-free connection to the turbine blade.

FIG. 6 illustrates, in a flowchart, an embodiment of a method converting wind power to electric power with a vertical axis wind turbine having moment-free connectors that connect the turbine blades to the blade arms in order to transmit a stress maxima to a structural strongpoint of the turbine blade away from a connection point of the first moment-free connector.

FIG. 7 illustrates, in a block diagram, an embodiment of an output plot of a wind farm of vertical axis wind turbines showing an optimum placement and arrangement of the vertical axis wind turbines on the plot of land.

FIG. 8 illustrates, in a block diagram, an embodiment of an output plot of a mixed field of vertical axis wind turbines and horizontal wind axis turbines showing an optimum placement and arrangement of the those vertical axis wind turbines on the plot of land.

FIGS. 9a-9b illustrate, in block diagrams, an embodiment of an interaction between a pair of vertical axis wind turbines to create a coupled vortex effect.

FIG. 10 illustrates, in a block diagram, an embodiment of an interaction between a horizontal axis wind turbine and a vertical axis wind turbine.

FIG. 11 illustrates, in a block diagram, an embodiment of a computing device to assist in the placement of one or more rows of vertical axis wind turbines in a plot of land.

FIG. 12 illustrates, in a flowchart, an embodiment of a method that places vertical axis wind turbines in a land plot with an optimal vertical axis wind turbine placement on the plot of land based on the factors to optimize an amount of electrical power density that this plot of land will produce.

FIG. 13 illustrates, in a flowchart, an embodiment of a method placing vertical axis wind turbines in a land plot to generate a three dimensional contour map representing the optimal placing and arrangement of each of the individual vertical axis wind turbines on the plot of land in order to produce the optimum amount of electrical power output for the plot of land.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. Some example implementations may include a machine-implemented method, a tangible machine-readable medium having a set of instructions detailing a method stored thereon for at least one processor, a vertical axis wind turbine module, a vertical axis wind turbine, and/or an automatic wind turbine placement device. The tangible machine-readable medium does not store transitory signals but do store electronic signals like a RAM, ROM, or Flash memory does.

The vertical-axis wind turbine design has a number of mechanical improvements. The turbine has multiple blade designs, such as a three-blade design and a four-blade design. One advantage of the three-blade design is low solidity. An improved efficiency occurs with three blades. Each vertical-axis wind turbine may be geographically placed in a specific array and orientation towards other turbines and against a landscape to cause beneficial power effects. Other improvements are described below as well as in the accompanying documents to this specification.

In general, a vertical axis wind turbine is discussed. In an embodiment, a vertical axis wind turbine may have a set of two or more turbine blades to capture air movement to generate power. One or more blade arms connect to the turbine blades to hold the turbine blades parallel to a rotating shaft. The rotating shaft couples into a rotor of an electrical power generator. The blade arm transmits torque from the first turbine blade to the rotating shaft to drive the rotor of the electrical power generator. A set of moment-free connectors connect the turbine blades to the blade arms to transmit a stress maxima to a structural strongpoint of a turbine blade away from a connection point of the moment-free connector. The moment-free connectors may be implemented in many forms including a hinged form and a clamp form. The rotating shaft may include multiple sections bolted together that cause improvements in straightness, positioning, and manufacturability of the rotating shaft. The turbine has at least an upper level/section and a lower level/section and each of these has its own set of two or more turbine blades. The vertical axis wind turbine has a tripod base for support stability upon which the turbine blades, blade arms, and shaft rotate on, where the main shaft fits through a center of the tripod base in order to give a very solid and stable form/base to the vertical axis wind turbine.

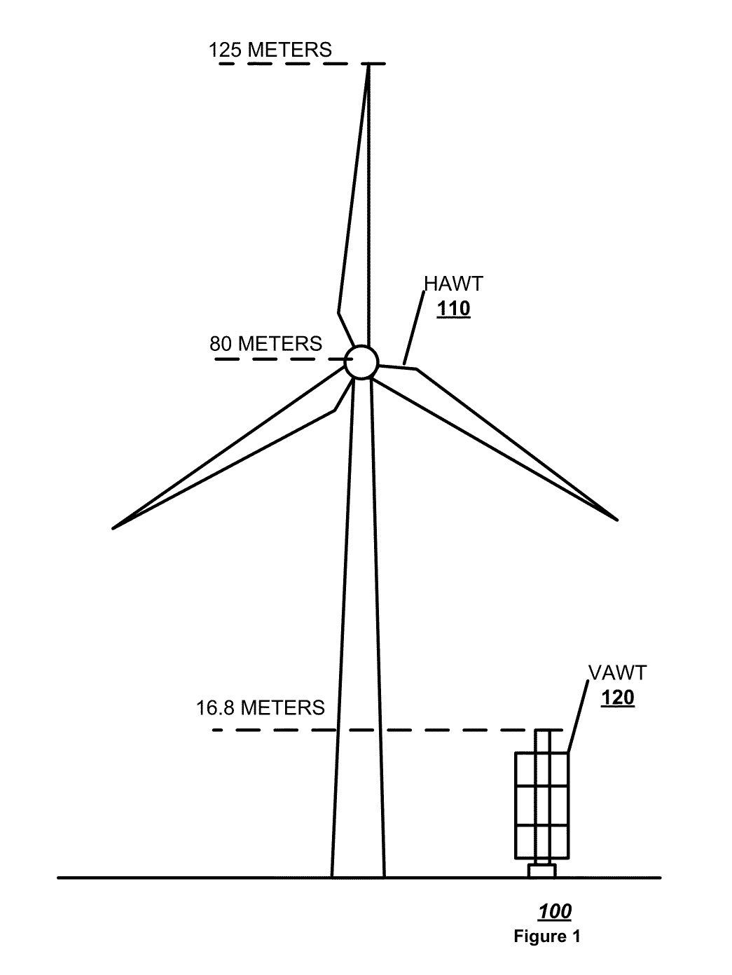

FIG. 1 illustrates, in a block diagram, an embodiment of a turbine comparison of vertical axis wind turbine and a horizontal axis wind turbine 100. A horizontal axis wind turbine (HAWT) 110 turns a set of turbine blades around a horizontal axis parallel to the ground. The horizontal axis wind turbine 110 may have a height of 125 meters, from blade tip to base. The axis of the horizontal axis wind turbine 110 may be at a height of 80 meters, with a 46.5 meter blade length.

A vertical axis wind turbine (VAWT) 120 turns a set of turbine blades around a vertical axis perpendicular to the ground. The vertical axis wind turbine 120 may have a height of 16.8 to 18 meters from the ground. The vertical axis wind turbine 120 may have a diameter of 5.5 meters. The main point is that the height of the VAWT does not interfere with the HAWT.

The vertical-axis wind turbines have significant advantages from turbine height, acoustic profile, land use (i.e. high production per square foot of plot of land needed), strength and durability of assembled vertical axis turbine, cost effectiveness, ease of shipping with every part designed to fit in a standard shipping container, ease of installation, ease of O&M, coupled vortex and plausible vertical mixing, ability to get permitted by local government agencies, etc.

In an embodiment, the turbine has the three blade and four blade designs with multiple sets of vertically aligned sets of blades being mounted on the shaft, such as 2-4 sets of vertically aligned blade sets. One advantage of the three-blade design is low solidity. An improved efficiency occurs with three blades rather than four blades.

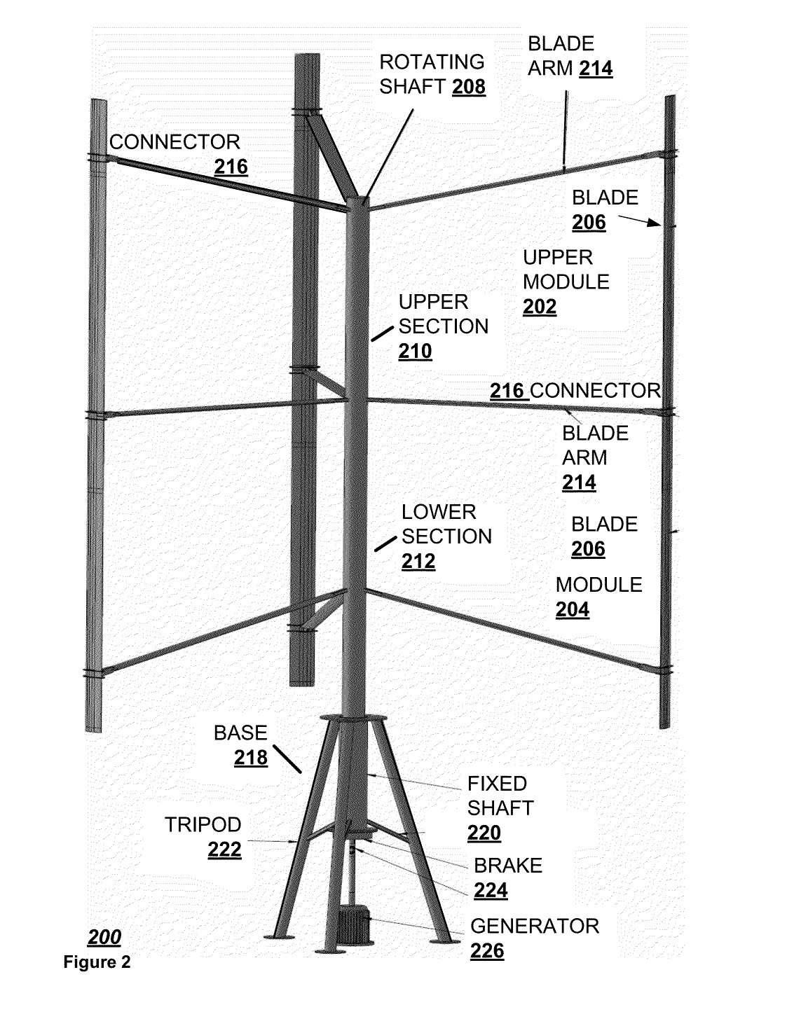

FIG. 2 illustrates, in a block diagram, an embodiment of an aligned vertical axis wind turbine with three or more turbine blades in an upper section of the turbine and a matching number of three or more turbine blades in a lower section of the turbine aligned with the three or more blades in the upper section 200. The aligned vertical axis wind turbine 200 may be divided into modules, with an upper vertical axis wind turbine module 202 and a lower vertical axis wind turbine module 204. In an aligned vertical axis wind turbine 200, the turbine blades 206 of the upper vertical axis wind turbine module 202 aligns with the turbine blades 206 of the lower vertical axis wind turbine module 204.

The aligned vertical axis wind turbine 200 may use a set of one or more turbine blades 206 to capture air movement to generate power. The turbine blades 206 may be an aluminum turbine blade 206, an aluminum alloy turbine blade 206, or made of a similar material, in order to create a light but durable turbine blade 206. In an embodiment, the turbine blades can be made of other materials like plastics. Each vertical axis wind turbine module may have three turbine blades 206 to give a good solidity effect and balance an amount of airflow to a neighboring vertical axis wind turbine 120 and the amount of power generated by each vertical axis wind turbine 120. The rotating shaft 208 of the aligned vertical axis wind turbine 120 may be divided into modules/sections to prevent gravity induced bending in the rotating shaft. An upper rotating shaft section 210 may be driven by the upper vertical axis wind turbine module 202, while a lower rotating shaft section 212 may be driven by the lower vertical axis wind turbine module 204.

A blade arm 214 may transmit torque from the turbine blade 206 to the rotating shaft 208. A moment-free connector 216 may connect the turbine blade 206 to the blade arm 214. The moment-free connector 216 may transmit a stress maxima to a structural strongpoint of the turbine blade 206 away from the moment-free connector 216, such as the turbine blade center.

A turbine base 218 may support the rotating shaft 208. The turbine base 218 may have a fixed shaft 220 to support the rotating shaft 208. A tripod 222 may vertically align the fixed shaft. An electromagnetic brake 224 with a manual release may control the rotations of the rotating shaft 208. An electrical power generator 226 with a rotor driven by the rotating shaft 208 may generate electrical power. A concrete foundation block may level the tripod 222. Note, the base may have multiple support legs such as a three or four legged support base.

The vertical-axis wind turbine is made up of multiple blades such as two sets of blades consisting of three each, which rotate around with the central support shaft. Each blade is attached at both ends to support arms with a moment-free connection in the flap-wise direction. The designs may have three blades in a set on a rotor or four in a module. In the three blades per rotor design, one less blade gives a lower percentage of solidity of 27%, which makes a higher efficiency, and thus gives up to 40% more power and revenue put out by the vertically axis turbine design using rotors with three blades per set. In another embodiment, the three blades per rotor design one less blade gives a lower percentage of solidity of 24.5%. Also, one less blade gives a lower cost in material to make. The three blades per module design may cooperate with the induction generator/motor, which has a self-start circuit programmed to assist in getting the rotor up to speed. Each blade may be up to 12 feet long and connect to the rotor. The lower three-blade/four blade per rotor set can use a hole to change blade pitch. Likewise, the braking system can couple to a compressed air cylinder that relinquishes/lets out air in steps to produce vertical motion to a disc in a step function to pitch the blade in discrete increments. This truncates the power curve into the limits of the generator.

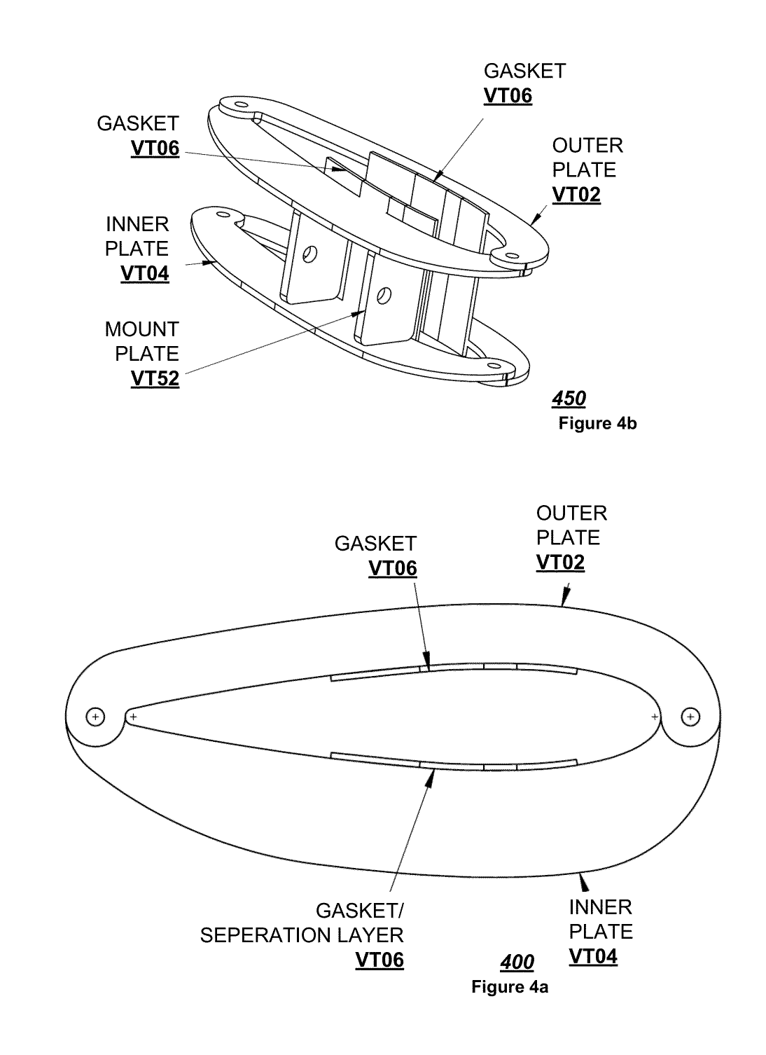

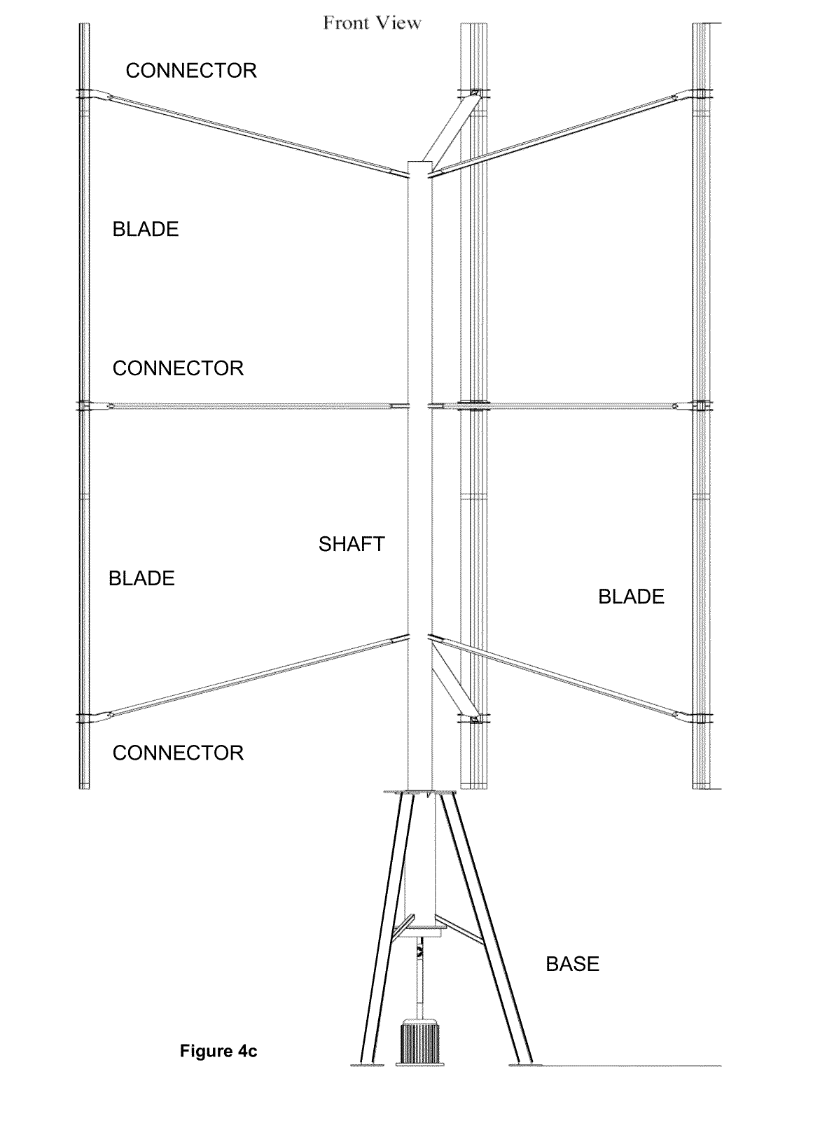

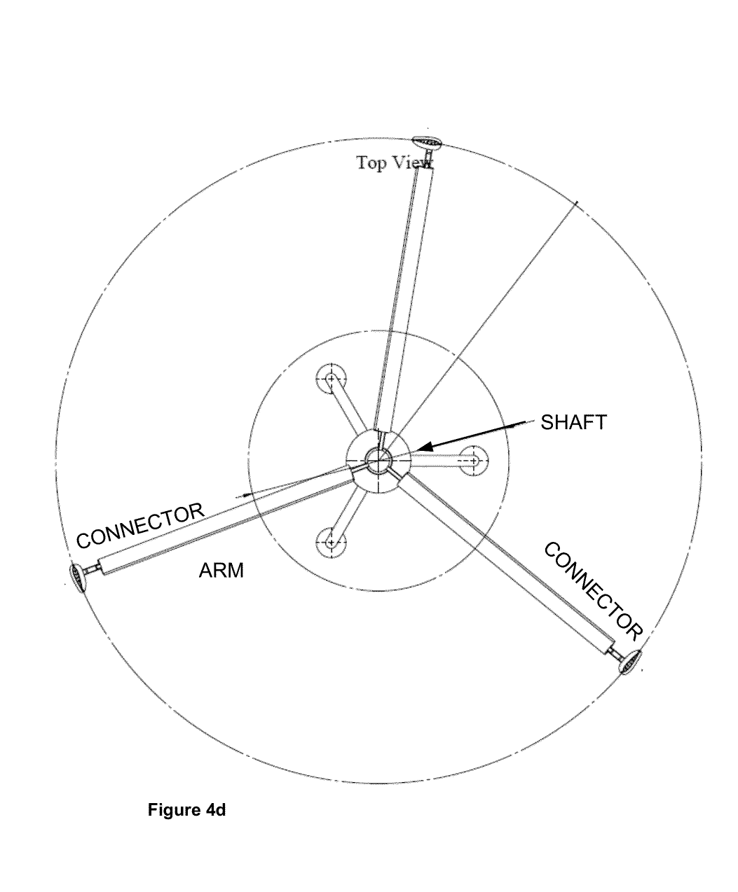

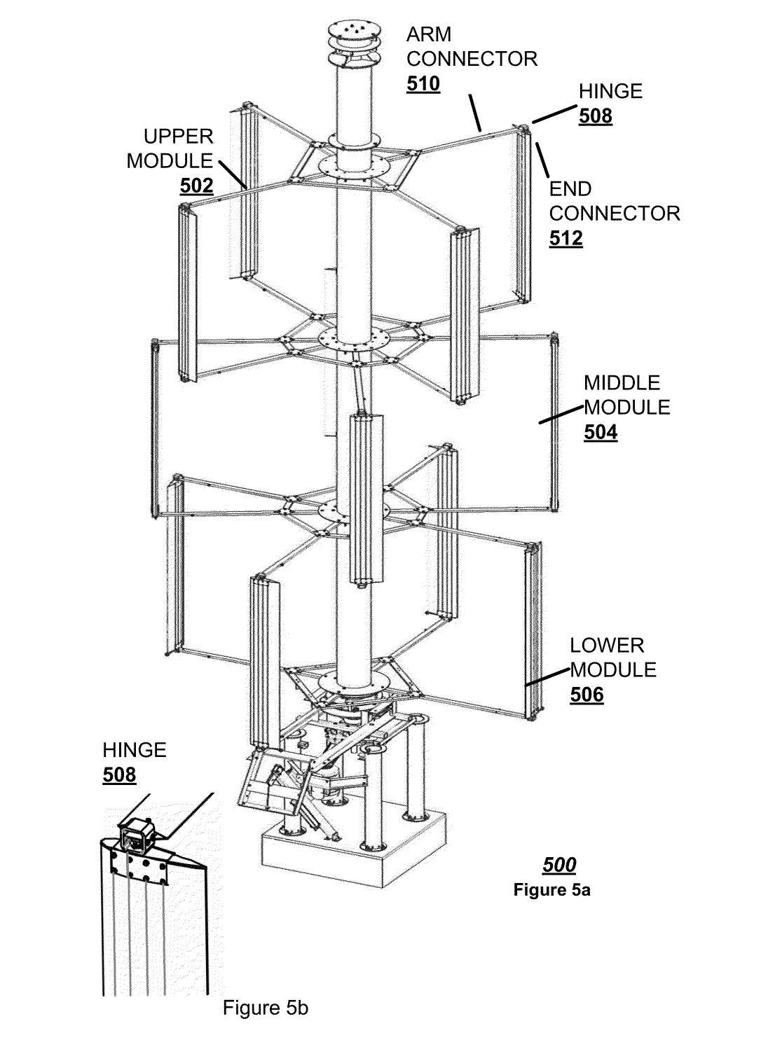

The vertical-axis turbines may use moment-free connections on blades. FIG. 5b shows a hinge based moment-free connection and FIG. 4a shows a flexible clamp-based moment-free connection. The blade ends can hinge to shift the maximum stress to the center of the blade (where it is strongest) rather than having the maximum stress at the connection points. Sub-components that help capture optimal use of the design include a Blade arm connector, Blade end connector, and Blade end fairings. The Blade arm connector (yoke system for aligned blades and non-aligned blades) can use a pin to hold it in place or for additional support a rectangular tube on a channel on/by the pin connection to hold it in place. The vertical-axis turbines may also change gear ratios by matching the belt sheaves to the desired ratio for that wind farm site.

Thus, in an embodiment, a vertical axis wind turbine may be constructed to better survive wear and tear while being more energy efficient. A turbine blade may capture air movement to generate power. A blade arm may hold the turbine blade parallel to a rotating shaft. The blade arm may transmit torque from the turbine blade to the rotating shaft to drive a rotor of an electrical power generator. A moment-free connector may connect the turbine blade to the blade arm to transmit a stress maxima to a structural strongpoint of the turbine blade away from the moment-free connector.

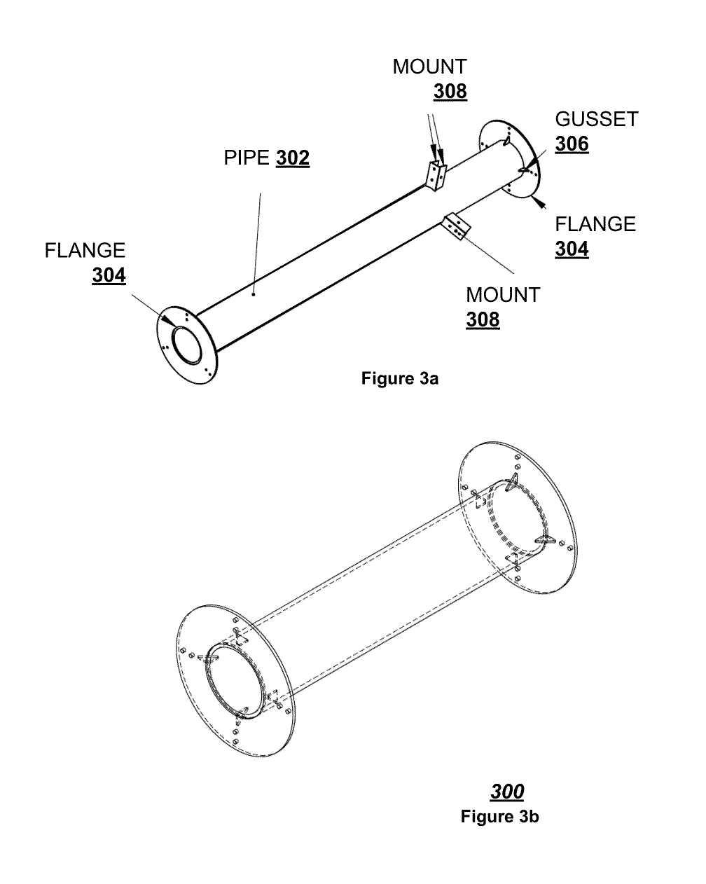

FIGS. 3a and 3b illustrate, in block diagrams, an embodiment of a sectional rotating shaft 300. The sectional rotating shaft 300 may have a pipe 302 main body. The sectional rotating shaft 300 may have a flange 304 to connect to other sectional rotating shafts 300. The lower flange 304 of the upper rotating shaft section 210 may be bolted to an upper flange 304 of the lower rotating shaft section 212. The flange 304 may be supported by one or more gusset plates 306. The sectional rotating shaft 300 may be connected to the blade arm 214 by an arm mount 308.

The turbine is made up of a multiple section shaft to control both ease of manufacturability of making multiple smaller sections of shaft and to control the bow angle within a given section of the shaft. In an embodiment, each section of the shaft is roughly about 7½ meters (m). The multiple shaft sections, such as four, couple together. In another embodiment, the shaft can consist of one 30-70 foot long continuous shaft.

Multiple shaft sections make it easier to manufacture sections with less angular bow from tip to end on the shaft. The shorter sections of shaft can be machined to tighter tolerances for angular bow. This is important because the shaft couples to a spherical rolling bearing that radially and horizontally supports the weight of the entire turbine structure including the shaft, and the angular bow should be low for a proper working relationship.

Thus, in an embodiment, the rotating shaft has multiple section tubes that cause improvements in straightness and positioning. By using the multiple section tube, the rotating shaft gains an accuracy of 1.19 mm for each 4.5 meters on flanges of 0.6 m diameter. The straighten tolerance of a tube is 0.002*L. This is helping the position of the next section tube and the final position of the blades. These gains were achieved by using a 0.1 mm machining. Better results, but with increased costs can be obtained by machining the flanges at 0.05 mm. A second positive aspect of the multiple piece shaft is the advantage in transportation and manipulation of the metallic on site.

The multiple sections of the shaft are machined to have tight tolerances for the straightness of the sections of the shaft and between the bolted connection points between the rotating sections of the shaft to eliminate and/or minimize the amount of overall bow angle between the bottom section of the shaft and the uppermost top section of the shaft. Each section of the shaft is made so that it is easily transportable and not too long in dimension such as 3 meter sections of shaft to be easily transportable and manufacturable. The shaft is also made out of a metal rugged material to be very durable as well as the blades and the clamp have a similar characteristic. Each section of shaft may then be easily bolted together when installed and on the site.

FIGS. 4a-4d illustrate, in block diagrams, an embodiment with multiple views of a moment-free connector where the clamp is a laser-cut steel clamp molded to fit the exact geometric shape of an aero foil of the turbine blade. Note, the clamp may also be a molded steel clamp or even a fiberglass clamp.

FIG. 4a illustrates, in a block diagram, an embodiment of a top view of a moment-free connector 216. The moment-free connector 216 may be a clamp that allows expansion or compression of the turbine blade 206. The clamp may be a laser-cut steel clamp molded to fit a geometric shape of the turbine blade. The clamp may have an outer clamp plate 402 and an inner clamp plate 404. An ultraviolet compression polymer gasket 406 may interface between the turbine blade 206 and the outer clamp plate 402 and the inner clamp plate 404 to prevent an adverse reaction between the aluminum and the steel.

FIG. 4b illustrates, in a block diagram, an embodiment of a perspective view 450 of a moment-free connector 216. The clamp may have a mounting plate 452 to connect the clamp to the blade arm 214. The clamp may allow enough movement between the turbine blade 206 and the blade arm 214 to move any stress point away from the weaker clamp and towards a stronger position, such as the center of the turbine blade 206.

The vertical axis wind turbine has moment-free connections between the rotating shaft and the blades of the turbine. The moment-free connections are hinged and/or flexible, to transmit the stresses into the center part of the blade where the blade is at its strongest structurally rather than at the edges of the blade. The moment-free connection may be a laser cut metal clamp that has been cut/molded to fit the shape of the foil of the blade in order to make a secure clamp around the blade with minimum amount of movement possible relative for the connection between the blade and the clamp. The moment-free clamp connection may have a gasket or separation layer between itself and an aluminum blade. The separation layer of is there to eliminate fatigue and the potential corrosive effects between two different metals in contact, the metal clamp and the aluminum blade.

FIG. 5a illustrates, in a block diagram, an embodiment of a vertical axis wind turbine 500 with at least an upper level and a lower level and each of these has its own set of two or more turbine blades that are offset with respect to each other. The offset vertical axis wind turbine 500 may have an upper vertical axis wind turbine module 502, a middle vertical axis wind turbine module 504, and a lower vertical axis wind turbine module 506. Each vertical axis wind turbine module may have turbine blades 206 offset from the turbine blades 206 in a neighboring vertical axis wind turbine module.

In an embodiment, the moment-free connector 216 may be a hinge 508 that shifts the stress maxima to a turbine blade center. The hinge 508 may move to move any stress point away from the weaker clamp and towards a stronger position, such as the center of the turbine blade 206. The hinge 508 may be coupled to the blade arm 214 by a blade arm connector 510. The hinge 508 may be coupled to the turbine blade 206 by a blade end connector 512.

The turbine may use aligned blades verses non-aligned blades going vertically down the centerline of the shaft. Three levels of sets with four blades per rotor or three blades per rotor may be used. The level of blades may create a lower, middle, and upper set of blades (12 total blades in a 4 set per rotor design and 9 total in a 3 set per design). The sets of blades may be non-aligned/offset with respect to each other. If the set of blades are offset, then generally a set of blades is offset to the other sets of blades by 30 degrees to make it appear 12 separate blades rotate around the shaft (in a four blade per set configuration). If the set of blades are aligned, then generally a first set of blades is directly inline and under another set's blades to make it appear as four continuous blades rotate around the shaft (in a four blade per set configuration).

The vertical axis wind turbines may have, in an embodiment, two sets of three blades that are in vertical alignment. Each vertical axis wind turbine is made up of two modules consisting of three blades each, which are aligned around the central support shaft. Each blade is attached at both ends to support arms (blade arms) with moment-free connection in the flap-wise direction. The edge-wise stress is very small compared to flap-wise stress from radial aero loading because tangential forces experienced by the blade are small and the blade section modulus is large in that direction. The rotors are designed to allow for counter-clockwise or clockwise rotation and ultimately will be installed in an array of turbines.

The vertical-axis turbines may use moment-free connections on blades. The blade ends can hinge to shift the maximum stress to the center of the blade (where it is strongest) rather than having the maximum stress at the connection points. Sub-components that help capture optimal use of the design include a Blade arm connector, Blade end connector, and Blade end fairings. The Blade arm connector (yoke system for aligned blades and non-aligned blades) can use a pin to hold it in place or, for additional support, a rectangular tube on a channel on/by the pin connection to hold it in place.

The turbine's max moment occurs at the midpoint of the blade because the blade connects to the horizontal blade support arms in a moment-free connection. For example, using simple beam theory, the maximum moment at the mid-point of the 3.66-meter long blade is as follows:

M (max)=w*l2/8, where w is the uniformly distributed load and l is the length of the beam (Manual of Steel Construction 13^{th} edition).

The maximum load occurs when the blade cord is oriented perpendicular to the wind; the load drops off as the angle of attack of the blade approaches zero. Using Sandia Lab's lift and drag coefficients for the NACA 0018 airfoil, the load on a single blade (100% drag in the normal direction) imparted by a 65.25 m/s wind speed is as follows:

D=Cd*q*A; where Cd is the drag coefficient, q is the dynamic pressure, and A is the platform area.

Using Sandia's drag coefficient of 1.8, dynamic pressure of 54.6 lbs/ft2, and platform area of 17.38, the load calculates at 1707 lbs or 774 kg. The section modulus of the VAWT turbine's 636G blade is 5.1 cubic inches (8.36 e-5 cubic m) perpendicular to chord, with a corresponding moment 30.7 kip in and bending stress of 41.4 M Pa, or 6.0 ksi. The tensile stress of 6061-T6 aluminum blades is 260 M Pa, providing a safety factor of 6.3.

The maximum resultant shaft moment occurs when the chord of all four blades per module are oriented 45 degrees to the wind because the sum of the loads on four blades are highest in that orientation. Therefore, conservatively, present bending loads on the shaft may assume an aligned turbine with blades aligned 45 degrees to the wind.

The resultant main shaft bending moments may be calculated by converting blade loads to concentrated loads imparted by the horizontal blade support arms, and adding the distributed load from wind drag on the 18-inch (457 mm) diameter schedule 10 steel shaft. The total vertical span of the shaft assembly from the bottom bearing to top bearing (including a portion of the drive shaft, brake actuation assembly, main shaft, shaft extension, and shaft adaptor) is 49.2 feet (top bearing is 57.5 feet from ground surface).

Given the loads presented above, the maximum moment is calculated analytically by adding the distributed load from drag on the shaft and the concentrated loads from the blades.

The moment from wind drag on the shaft:

Mmax=wl2/8

Mx=wx(l−w)/2

Where w is the distributed load, l is the shaft length, and Mx is the moment at any location, x.

Moments from point loads were calculated using shear and distance relationships as presented above. The sum of the moments equals the total moment at any location on the shaft.

Given that the shaft is supported on both ends by a moment-free connection (the bearings adjust to angular mis-alignment under loads), the maximum moment is near the midpoint of the shaft at the top of the second module connection point for the blade support arms.

The maximum moment is 120 k lbs ft (162.7 kNm). The section modulus of the 18-in diameter shaft is 61.1 cubic inches (1e-3 cu m), with a resultant bending stress of 23.4 ksi (161.3 MPa). The tensile strength of the Hybox 355 structural steel used in the main shaft is between 470 and 630 MPa, providing a safety factor of between 2.9 and 3.9. If Class III winds (55.9 m/s) are assumed, the shaft bending stress reduces to 92 MPa.

The vertical-axis turbines may use a blade braking system that has several advantages. The blade braking system combines a mechanical brake with a pin mechanism that engages the aerodynamic brake (i.e. one of the bottom blades pitches to create drag). The bottom module blades pitch during shut down, thus providing aerodynamic braking.

Note that the VAWT can be a stall-regulated turbine, which incorporates an induction generator so that the turbine generates at a constant rpm. Also, under normal operation, the blades are at a fixed angle to the radial arm that attaches to the shaft. Therefore, the rotor, apart from the bearings and drive train, acts as a single moving part while generating electricity. The bottom module blades pitch 17 degrees during shut down, thus providing aerodynamic braking.

The design of gearbox-belts-generator has many advantages. A design that makes it easier for the turbine to self-start with a low torque demand at start up. The gearbox cooperates with shock absorbers to prevent unstable motion and lock nuts to prevent backwards rotation. The gearbox tries to place little to no load on gearbox bearings. The gearbox couples to the drive shaft where the high-speed shaft is offset from the gearbox. The design also allows tension to be set with tension rods. Note, taller horizontal-axis turbines do not generally use belts, but the belt drive benefits this vertical-axis turbine.

Bearing arrangement exists at top and bottom of the main shaft. The shaft is supported on both ends by a moment-free connection. The bearings adjust to angular mis-alignment under loads. The turbine uses a roller thrust bearing versus a standard bearing improved the lifetime bearing approximately four times.

The turbine may have a tripod base for support stability upon which the blades and shaft rotate on. The main shaft fits through a center of the tripod base in order to give a very solid and stable form/base to the turbine. The tripod base is mounted on to a level concrete platform in order to allow each vertical axis wind turbine to withstand and operate in winds up to 50 m/s. The tripod base and connections into the concrete platform are made out of a strong enough material and heavy enough material to give this solid base to the turbine.

The tripod base, the blades, the clamp, and the sections of shaft are all made so that they are simple to fabricate and simple to install, which results in reduced cost and reduced need for skilled labor.

In another embodiment, the turbine may be secured by guy cables. Three guy cables per individual turbine or when an array of turbines is installed at a site, typically four guy cables, two forward and two aft (both 45 degrees apart), are connected to each turbine as well as to a pipe connecting all of the turbines in that linear array. Thus, in an array set, each turbine is supported by at least four guy wires and a top support strut installed between adjacent turbines to provide redundant support. The front turbine and end turbine in the array have at least one more additional guy cable attached to them. The tension is set in the guy cables. Neighboring turbines can share the same foundation cutting down on the number of foundations created and poured.

The guy cable support cooperates with the spherical rolling bearing in that it aligns the weight of the turbine into a vertical-axis and onto the spherical rolling bearing. Also, when the guy cables are anchored at a 45 degree angle to the shaft then horizontal wind loads are transferred by the guy cables to being a vertical load down the shaft and onto the rolling bearing. No external steel framed support structure is required for the guy cable support system. The guy cable support system incorporates less overall steel in prior designs and brings costs down. Thus, embodiments of the VAWT can use some sort of anchoring system such as guy wires, tripod base, or similar mechanism.

Again, the turbine may use aligned blades verses non-aligned blades going vertically down the centerline of the shaft. For example, three levels of sets with four blades per rotor or three blades per rotor may be used as well as two levels of sets of three blades per rotor. The levels of blades create a lower, middle, and upper set of blades (12 total blades in a 4 set per rotor design and 9 total in a 3 set per design). The sets of blades may be non-aligned/offset with respect to each other. If the set of blades are offset, then generally a set of blades is offset to the other sets of blades by 30 degrees to make it appear 12 separate blades rotate around the shaft (in a four blade per set configuration). If the set of blades are aligned, then generally a set of blades is directly inline and underneath another sets of blades to make it appear as four blades that rotate around the shaft (in a four blade per set configuration).

The turbine has couplings and other mechanical enhancements that make the turbine more rugged. The vertical-axis wind turbine design and its couplings make the turbine more rugged so the bearing needs to be replaced less often.

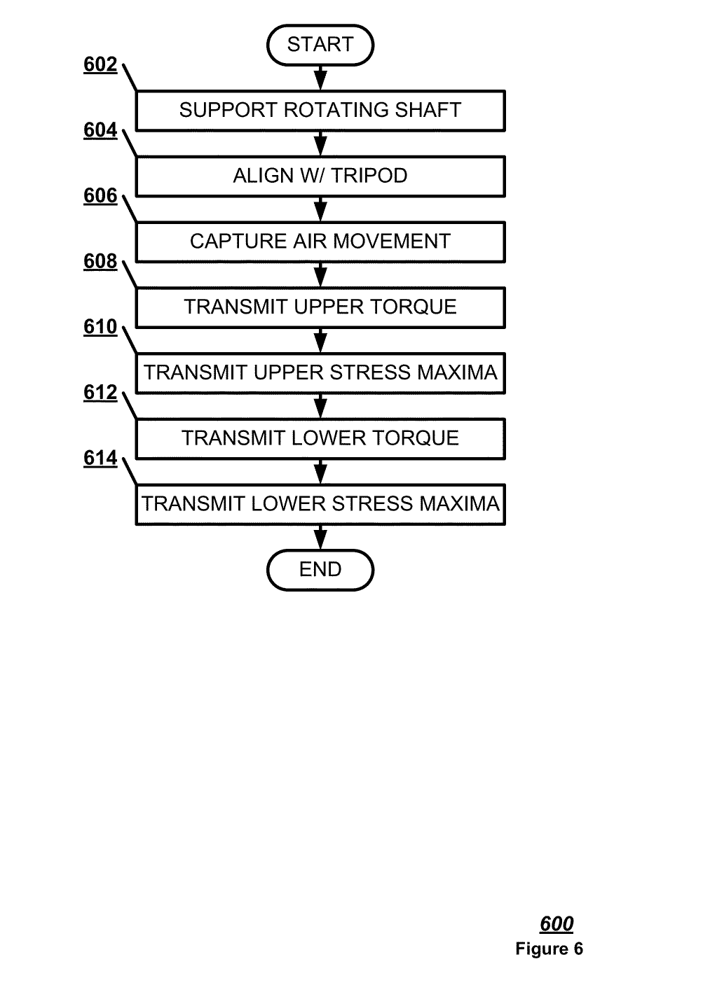

FIG. 6 illustrates, in a flowchart, an embodiment of a method converting wind power to electric power with a vertical axis wind turbine having moment-free connectors that connect the turbine blades to the blade arms in order to transmit a stress maxima to a structural strongpoint of the turbine blade away from a connection point of the first moment-free connector. The fixed shaft 220 may support the rotating shaft 208 (Block 602). The tripod 222 may vertically align the fixed shaft 220 (Block 604). Three upper section turbine blades 206 and three lower section turbine blades 206 aligned with the three upper section turbine blades 206 may capture air movement to generate power (Block 606). An upper section top blade arm 214 and an upper section bottom blade arm 214 may transmit torque from each upper section turbine blade 206 to an upper section rotating shaft 210 (Block 608). An upper section top moment-free connector 216 connecting each upper section top blade arm 206 and an upper section bottom moment-free connector 216 connecting each upper section bottom blade arm 206 to each upper section turbine blade 206 may transmit an upper section stress maxima to each upper section turbine blade center of the three upper section turbine blades (Block 610). A lower section top blade arm 214 and a lower section bottom blade arm 214 may transmit torque from each lower section turbine blade 206 to a lower section rotating shaft 210 (Block 612). A lower section top moment-free connector 216 connecting each lower section top blade arm 206 and a lower section bottom moment-free connector 216 connecting each lower section bottom blade arm 206 to each lower section turbine blade 206 may transmit a lower section stress maxima to each lower section turbine blade center of the three lower section turbine blades (Block 614).

Next, the software is configured with algorithms and routines to maximize the amount of power density that a given plot of land will produce for a wind farm based on factors including the contour of the land, the wind shape of the land especially as the topography creates different near-ground wind speed up effects, potentially multiple wind directions occurring within the land, placement constraints of existing objects on the land, including buildings and/or horizontal axis wind turbines, property boundary lines, and other factors.

The software and its routines and algorithms generally at least pair two vertical axis wind turbines together in order to create the coupled vortex effect, which results in a higher power production in both of those turbines. The algorithm also tries to optimize in one instance the intermixing of the placement of rows of vertical axis wind turbines with rows of the existing horizontal axis wind turbines. The algorithms take into account both placing a given amount of vertical axis wind turbines on a plot of land and maximizing the efficiency of the placed vertical axis wind turbines on that plot of land based on the wind direction, turbine solidity, and array wake effects, distance between arrays and rows of arrays and other factors. The algorithms also try to account for: the increased wind speed that occurs over and around arrays and the benefits this can create for downwind HAWTs and VAWTs; the beneficial effects of vertical mixing in order to create changes in downwind pressure and resulting vertical mixing that pulls down more air to make the winds driving the horizontal axis wind turbines stronger. The algorithms take into account that the geography of the land may not all be flat; and thus, have contours of hills and ridges to affect the wind flow, speed, and direction of wind on that plot of land.

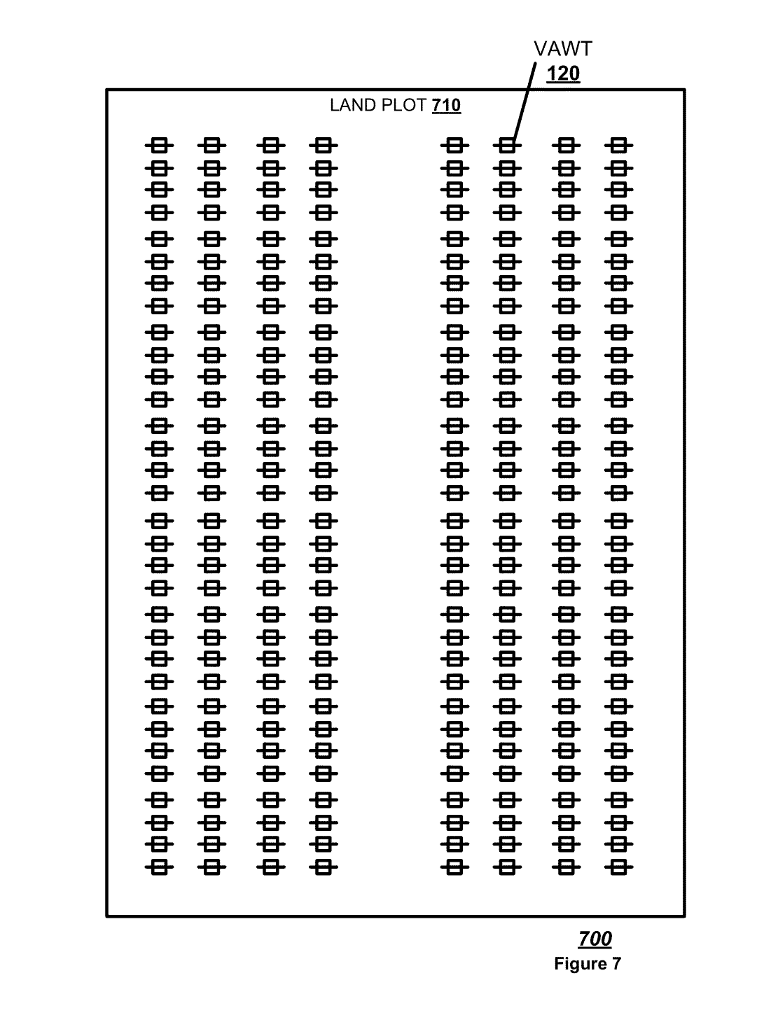

FIG. 7 illustrates, in a block diagram, an example an output plot from the software of a wind farm 700 of vertical axis wind turbines 120 showing an optimum placement and arrangement of the vertical axis wind turbines on the plot of land. The homogenous wind farm 700 of vertical axis wind turbines may be placed on a land plot 110. The land plot 110 may be an acreage, or one kilometer by one kilometer limited land area. The homogenous wind field 700 may have one or more vertical axis wind turbines 120 arranged in an optimal vertical axis wind turbine placement on the land plot 110 to create an optimal electrical power production. The optimal vertical axis wind turbine placement may be arranged in rows or randomly.

As discussed above, each vertical axis wind turbine may have a set of multiple blades per level. Setting, for example, three blades per level and having at least two levels of blades creates both a greater efficiency for each vertical axis wind turbine relative to the amount of wind coming into the turbine and the amount of electrical generation out of that vertical axis wind turbine when two or more vertical axis wind turbines are set into a row of turbines. The three-blade configuration per level gives a better solidity and resulting wake effect for downwind VAWTs.

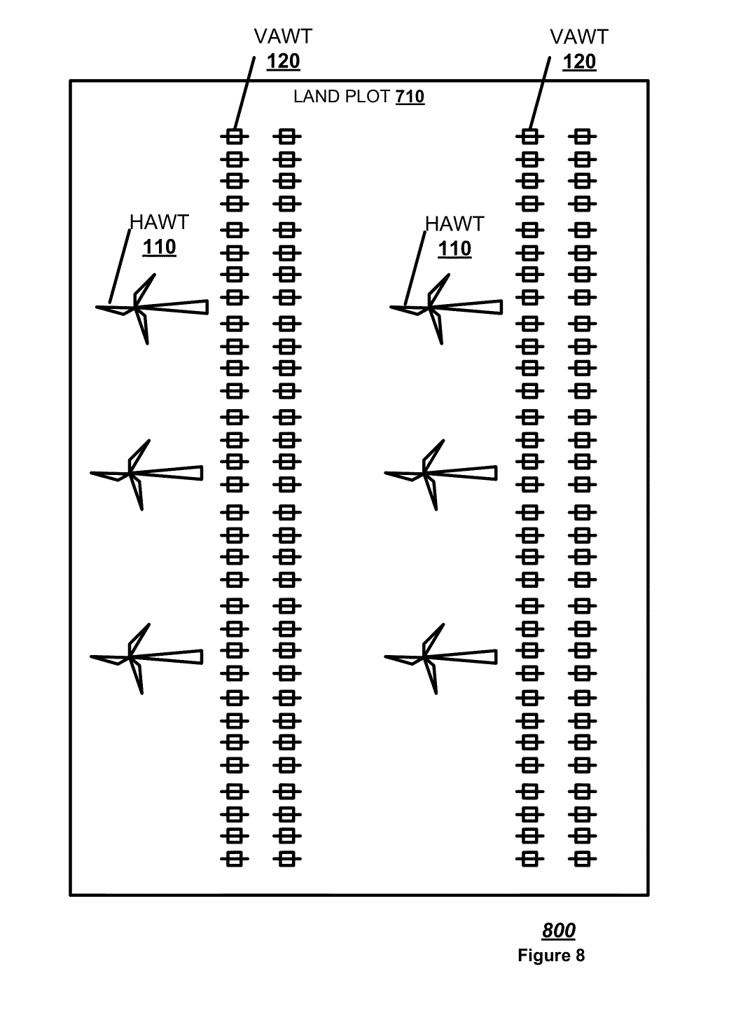

FIG. 8 illustrates, in a block diagram, an example output plot from the software for a mixed wind field 800 of vertical axis wind turbines 120 and horizontal wind axis turbines 110 showing an optimum placement and arrangement of the vertical axis wind turbines on the plot of land. The land plot 710 may have both horizontal axis wind turbines 110 and vertical axis wind turbines 120. The horizontal axis wind turbines 110 may be pre-existing on the land plot 710 before the vertical axis wind turbines 120 are installed. The vertical axis wind turbines 120 may be installed by taking into account air current changes caused by the presence of the horizontal axis wind turbines 110.

Vertical-axis wind turbines may be used to ‘in-fill’ the understory of wind farms. Vertical-axis wind turbines may be geographically placed in a specific array and orientation with beneficial power effects. Multiple arrays of vertical-axis turbines may be intermixed with existing horizontal axis turbines to increase the power density of a wind farm per acre. Integration of the vertical-axis turbines with existing wind farm acreage increases the power density of that wind farm, especially in onshore wind farms.

As discussed, HAWT have an average 46.5 meters blade length, which is one factor that causes a wide gap in between rows of HAWTs. A vertical axis wind turbine may have an average 17 meter height with a diameter of 5.5 meters. One or more rows of VAWTs may be placed in between each HAWT width wise and depth wise. Also, VAWT may be placed closer to the property line than can a HAWT. Thus, the rotor diameter setback from property line is less for the VAWT allowing even more VAWT to be placed in the geographic area of a Wind Farm. In addition, different patterns of pairs of turbines can allow for higher densities of VAWT rotor swept area and more cost effective use of the land.”

Vertical-axis wind turbines create opportunity to increase the utilization of existing infrastructure (capacity factor improvement) from approximately 25% on average currently to as much as 60% on average.

The vertical-axis wind turbine arrays make sure of optimal use of a plot of land situated in a high-wind zone. The turbines perform better the closer they are spaced, and traditional tall turbines perform better the further they are spaced (i.e. high production in small amount of space close to the ground).

One or more rows of VAWTs are placed in the current high wind, existing open land between existing rows of horizontal axis wind turbines (tall wind turbines) in a wind farm. Inserting VAWTs creates electrical generating revenue in non-revenue producing land for Wind Farm developers.

The array of rows of VAWTs capture the understory of the wind. Wind Farm understory utilization is beneficial because 25% of all commercial Wind Farms globally have strong ground level winds making VAWT understory turbines highly profitable.

Referring to FIG. 1, the visual impact of vertical-axis wind turbines is far less than tall turbines. For example, the top of the vertical-axis wind turbines stands approximately 60 feet versus some tall turbines reaching approximately 415 feet. Also, the vertical-axis wind turbines can sit underneath existing tall turbines or below ridgelines.

The vertical-axis wind turbines have an acoustic profile that is quieter than for taller turbines. The vertical-axis wind turbines have the ability to withstand near ground turbulence. Thus, the vertical-axis wind turbines are utility scale turbines that can withstand the turbulence. The vertical-axis wind turbines have durability paired with cost effective design on a turbine large enough for utility industry. This combination suits the required needs for a commercial power generating turbine.

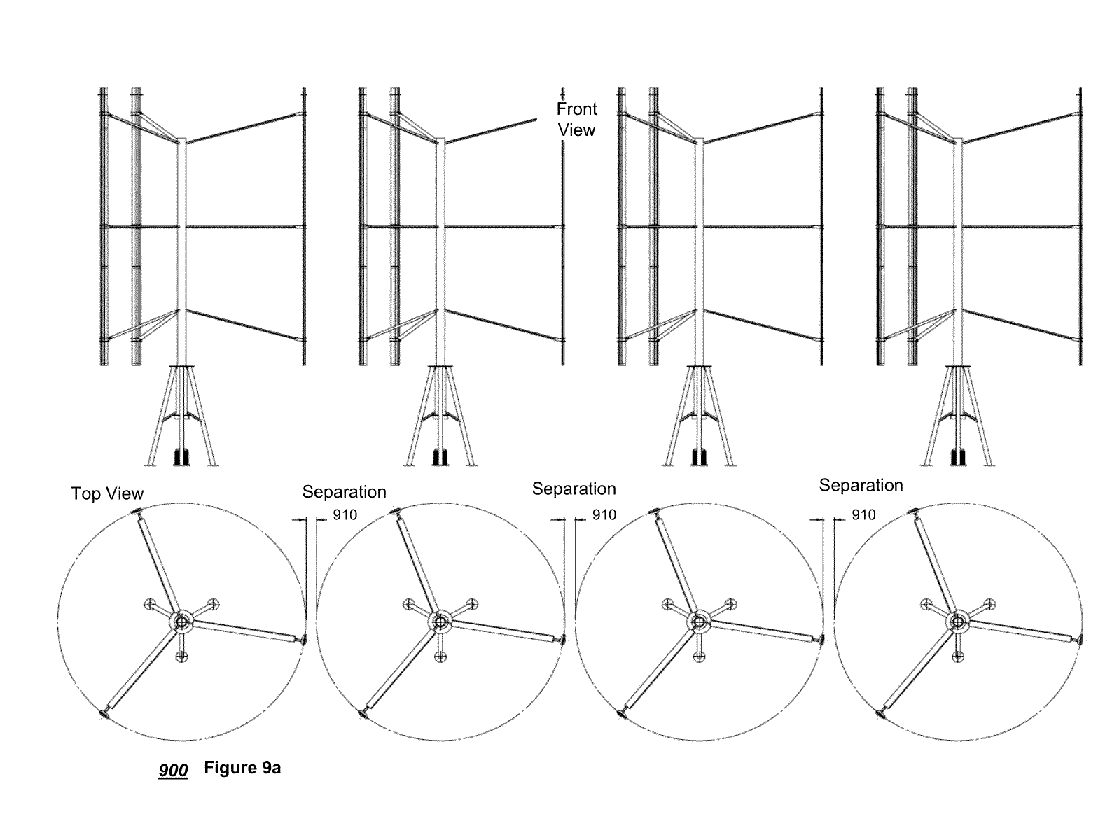

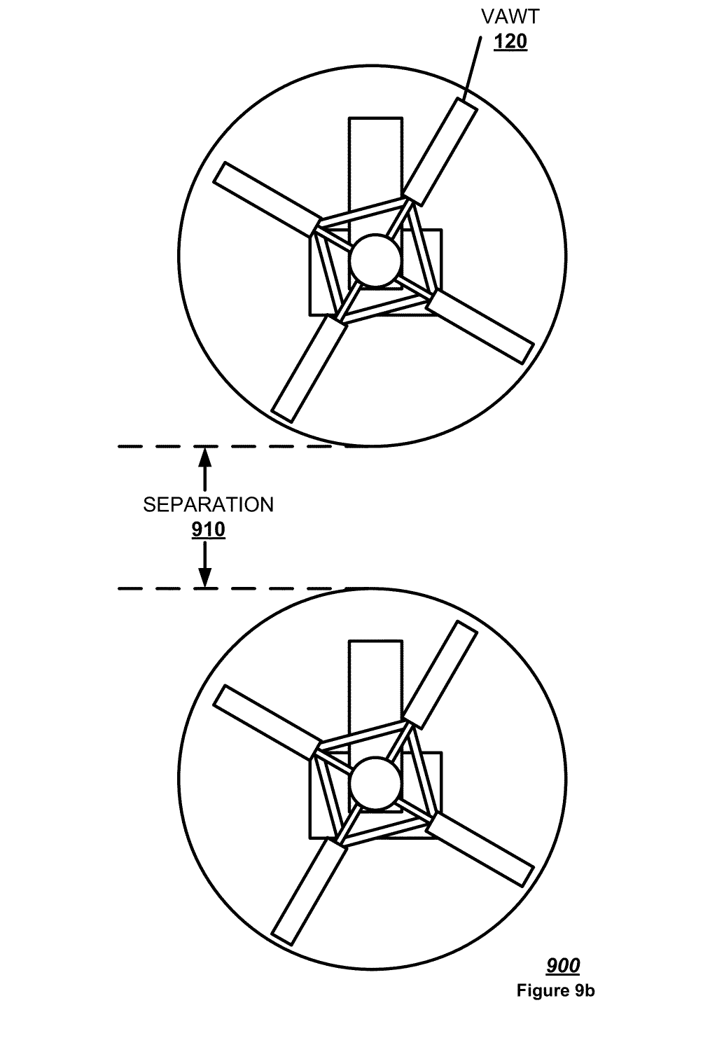

FIGS. 9a-9b illustrate, in block diagrams, an embodiment of an interaction 900 between a pair of vertical axis wind turbines 120. The separation 910 of the vertical axis wind turbines 120 may be placed to create a coupled vortex effect, wherein the rotation of one vertical axis wind turbine 120 affects the rotation of the second vertical axis wind turbine 120. By creating this coupled vortex effect, the electrical power production of both vertical axis wind turbines 120 may be increased.

Also, the vertical-axis wind turbines use a coupled vortex, which increases in performance by the manner of placement of these paired turbines. Also, a potential for vertical mixing exists based on the flow field impact of a coupled vortex dynamic.

The ‘Coupled Vortex’ dynamic increases the power performance of arrays of neighboring turbines by 10% or more due to the close proximity of turbine placement AND the physics of counter-rotating and co-rotating spin direction, which creates different shed vortices In general, the closer the placement of the VAWTs in an array, the greater the impact. For example, the ‘Coupled Vortex’ dynamic may increase the power performance of turbines by 25% due to the close proximity of turbine placement (<Y blade length) AND counter-rotating spin direction, which creates a vortex effect that increases power production.

The placement of the vertical axis wind turbine allows more power density per acre because more turbines can be placed within that acreage. The vertical orientated blades of the VAWT do not need to spread out horizontally as much as the blades of the HAWT and can be placed closer together than HAWTs. Thus, more vertical axis wind turbines may be placed within that same amount of acreage.

Tall turbines in a 15 miles per hour (mph) wind perform ‘as if’ those horizontal axis wind turbines were in an equivalent 16.5 mph wind. The higher the energy yield from a plot of land situated in a high-wind zone, the better the results.

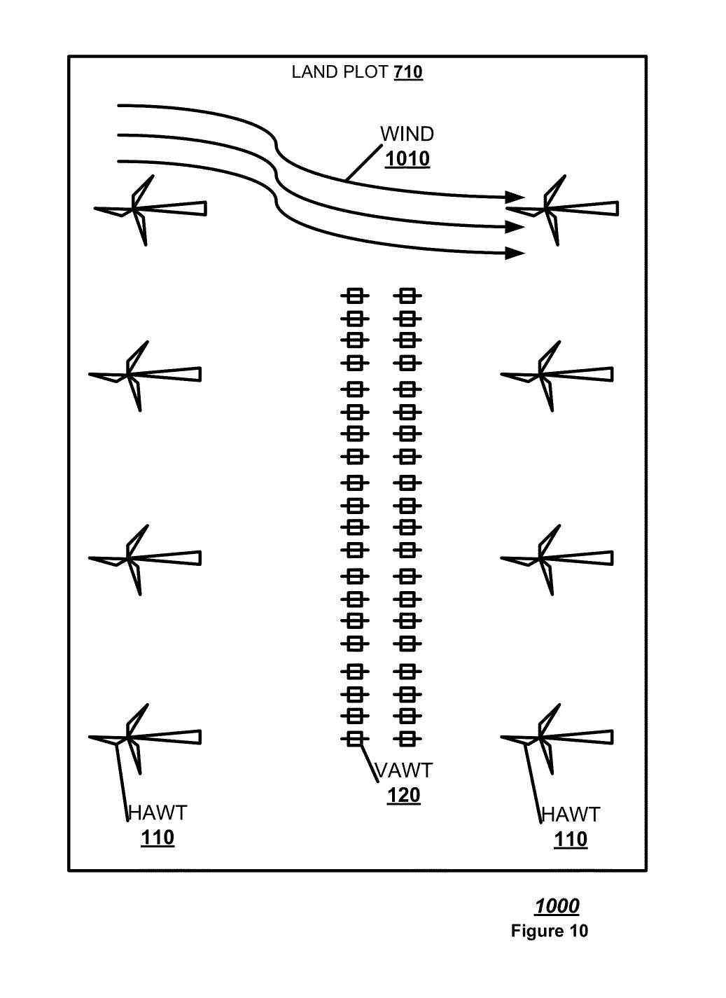

FIG. 10 illustrates, in a block diagram, an embodiment of an interaction 1000 between a horizontal axis wind turbine 110 and a vertical axis wind turbine 120. A vertical mixing interaction may occur. One group of vertical axis wind turbines 120 may increase the airflow in the land plot 710 to the horizontal axis wind turbines 110, increasing its electrical power production. For example, if one set of vertical axis wind turbines 120 is sandwiched between two rows of horizontal axis wind turbines 110, an air flow passing above and around the first row of horizontal axis wind turbines 110 may be pulled down by the vertical axis wind turbines 120 to impact the air flow that enters the second row of horizontal axis wind turbines 110.

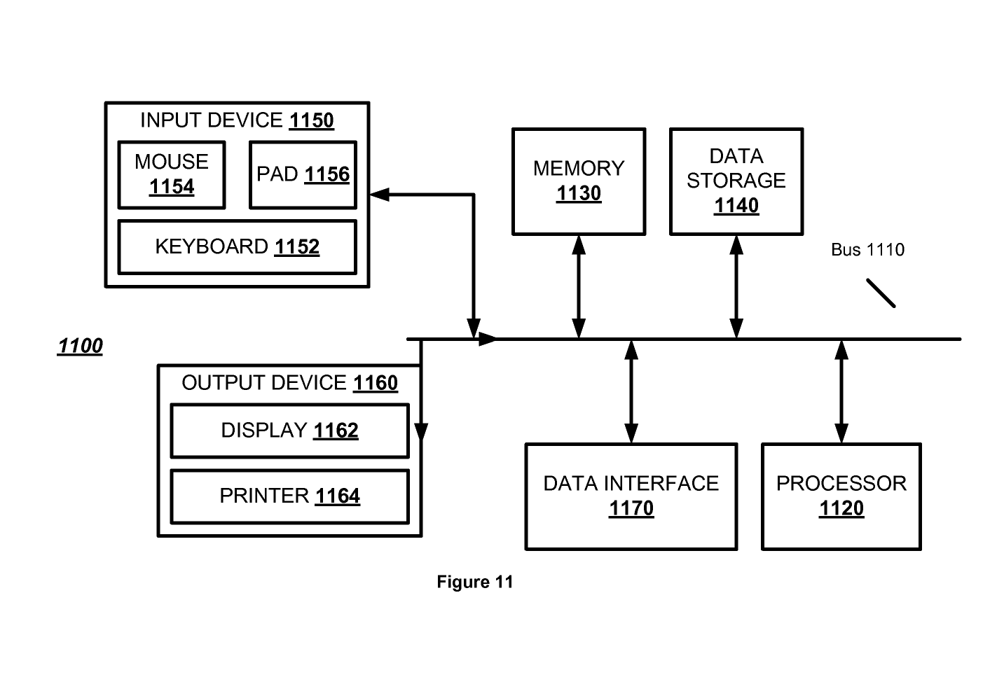

FIG. 11 illustrates a block diagram of an exemplary computing device 1100, which may act as an automatic wind turbine placement device. The computing device 1100 may combine one or more of hardware, software, firmware, and system-on-a-chip technology to implement an automatic wind turbine placement device. The computing device 1100 may include a bus 1110, a processor 1120, a memory 1130, a data storage 1140, an input device 1150, an output device 1150, and a data interface 1170. The bus 1110, or other component interconnection, may permit communication among the components of the computing device 1100.

The processor 1120 may include at least one conventional processor or microprocessor that interprets and executes a set of instructions. The memory 1130 may be a random access memory (RAM) or another type of dynamic data storage that stores information and instructions for execution by the processor 1120. The memory 1130 may also store temporary variables or other intermediate information used during execution of instructions by the processor 1120. The data storage 1140 may include a conventional ROM device or another type of static data storage that stores static information and instructions for the processor 1120. The data storage 1140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 1140 may store a set of instructions detailing a method that when executed by one or more processors cause the one or more processors to perform the method. The data storage 1140 may also be a database or a database interface.

The input device 1150 may include one or more conventional mechanisms that permit a user to input information to the computing device 1100, such as a keyboard 1152, a mouse 1154, a voice recognition device, a microphone, a headset, a touch screen, a touch pad 1156, a gesture recognition device, etc. The output device 1160 may include one or more conventional mechanisms that output information to the user, including a display 1162, a printer 1164, one or more speakers, a headset, or a medium, such as a memory, or a magnetic or optical disk and a corresponding disk drive. The data interface 1170 may include any transceiver-like mechanism that enables computing device 1100 to communicate with other devices or networks. The data interface 1170 may include a network interface or a transceiver interface. The data interface 1170 may be a wireless, wired, or optical interface.

The computing device 1100 may perform such functions in response to processor 1120 executing sequences of instructions contained in a computer-readable medium, such as, for example, the memory 1130, a magnetic disk, or an optical disk. Such instructions may be read into the memory 1130 from another computer-readable medium, such as the data storage 1140, or from a separate device via the data interface 1170.

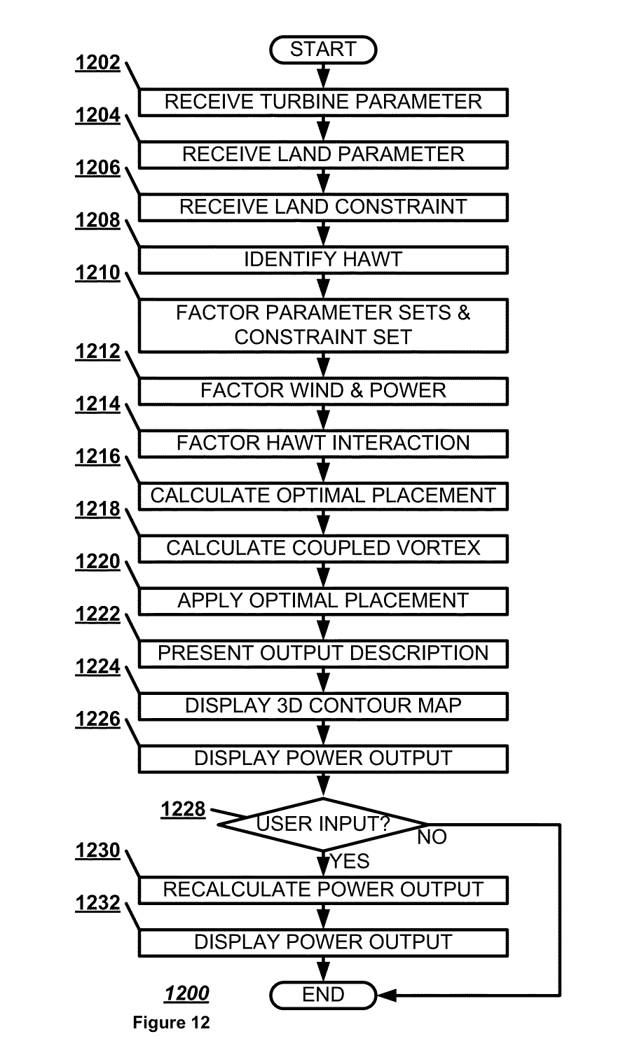

FIG. 12 illustrates, in a flowchart, an example of a method 1200 placing vertical axis wind turbines 120 in a land plot 710 with an optimal vertical axis wind turbine placement on the plot of land based on the factors to optimize an amount of electrical power density that this plot of land will produce. An automatic wind turbine placement device may receive at least one of a power curve and a wake coefficient as a turbine parameter set (Block 1202). The power curve describes power production in relation to wind input. The wake coefficient describes wake smoothness over distance and topography. The automatic wind turbine placement device may receive at least one of a land location, a land elevation, a wind speed schedule, a wind direction schedule, a wind rose, and a contour map as a land parameter set, and equations involving topographically or array induced speed up effects on the wind speeds over and around contours (Block 1204). A wind speed schedule describes the speed of the wind at a location based on the time of year. A wind direction schedule describes the direction of the wind at a location based on the time of year. A wind rose combines the wind speed schedule and the wind direction schedule. The contour map describes the elevation of a location within a land plot 710. The automatic wind turbine placement device may receive at least one of a landmark feature and a technical feature for the land plot 710 (Block 1206). A landmark feature is a physical feature of the land plot 710, such as a river, a cliff, woods, or other topographic feature. A technical feature is a technical aspect of the land plot 710, such as a transformer, a cable, a horizontal axis wind turbine 110, or other electrical device. A topographic effect can account for how pressure changes cause by objects can cause the wind speed to increase or slow down as wind moves over, around, and downwind of the object.

The automatic wind turbine placement device may identify a horizontal axis wind turbine 110 in the land plot 710 (Block 1208). The automatic wind turbine placement device may factor a turbine parameter set describing a vertical axis wind turbine set with a land parameter set and a land constraint describing the land plot into an optimal vertical axis wind turbine placement (Block 1210). The automatic wind turbine placement device may factor at least one of a wind interaction within the vertical axis wind turbine set and an individual power production by a vertical axis wind turbine set member into the optimal vertical axis wind turbine placement (Block 1212). The automatic wind turbine placement device may factor a wind interaction between a horizontal axis wind turbine 110 and the vertical axis wind turbine set and vice versa (Block 1214).

The automatic wind turbine placement device may calculate an optimal vertical axis wind turbine placement on the land plot 710 to maximize electrical power production based on the turbine parameter set and the land parameter set (Block 1216). The automatic wind turbine placement device may calculate a coupled vortex effect between a first vertical axis wind turbine and a second vertical axis wind turbine of the vertical axis wind turbine set into the optimal vertical axis wind turbine placement (Block 1218). The automatic wind turbine placement device may apply the optimal vertical axis wind turbine placement to a land plot description (Block 1220).

The automatic wind turbine placement device may present an output land plot description describing the optimal vertical axis wind turbine placement in relation to the land plot 710 to a user (Block 1222). The automatic wind turbine placement device may display a three dimensional contour map representing the optimal vertical axis wind turbine placement of the vertical axis wind turbine set (Block 1224). The automatic wind turbine placement device may display a resulting power output for the optimal wind turbine placement (Block 1226). If the automatic wind turbine placement device receives a user placement of a member vertical axis wind turbine of the vertical axis wind turbine set (Block 1228), the automatic wind turbine placement device may recalculate a resulting power and energy output for the optimal wind turbine placement based on a user placement of a member vertical axis wind turbine of the vertical axis wind turbine set (Block 1230). The automatic wind turbine placement device may display the recalculated resulting power and energy output (Block 1232).

Note, the placement of the next array of VAWTs downwind can be closer than ten rotor diameters because a coupled vortex effect creates less downwind wake and faster near ground wind speeds than VAWTs not placed as closely as the coupled vortex effect (CVE) allows. In an embodiment, the turbines may be placed closer than 0.5 rotor diameters between passing blades. Also, the VAWT arrays of various lengths, when place certain distances upwind of a HAWT, increase the amount of air flow that enters the HAWT, which then produces more energy than it would have without the VAWT array upwind.

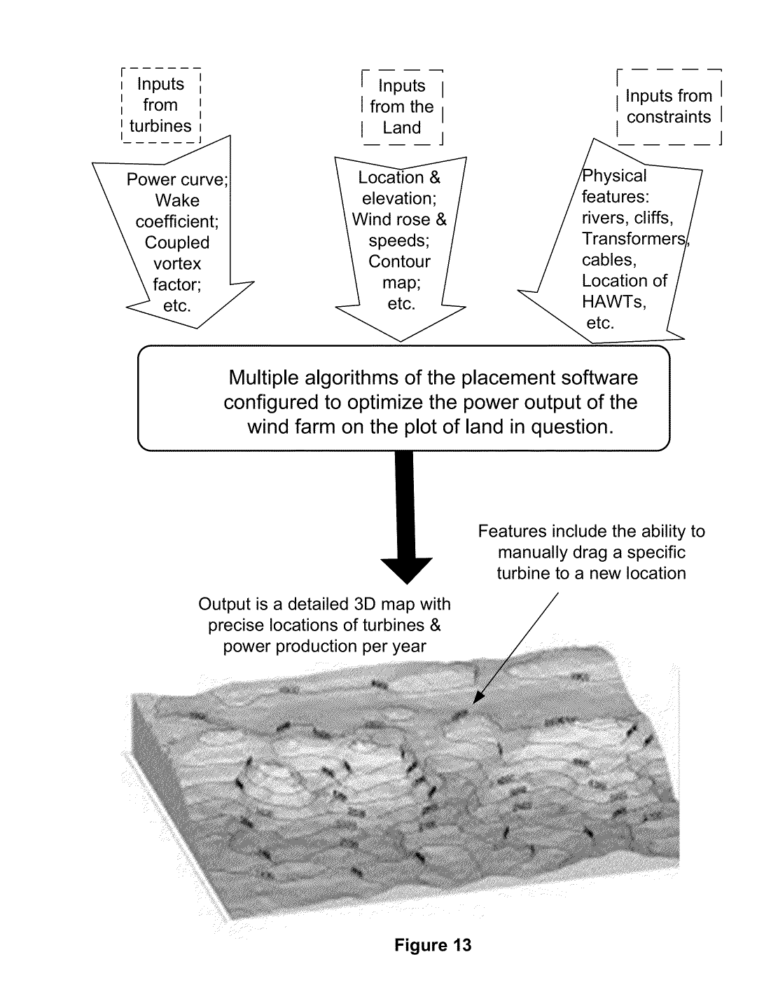

FIG. 13 illustrates, in a flowchart, an embodiment of a method placing vertical axis wind turbines in a land plot to generate a three dimensional contour map representing the optimal placing and arrangement of each of the individual vertical axis wind turbines on the plot of land in order to produce the optimum amount of electrical power output for the plot of land.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computing device-executable instructions include, for example, instructions and data which cause a general purpose computer, special purpose computer, or special purpose processing device to perform a certain function or group of functions. Computing device-executable instructions also include program modules that are executed by computing devices in stand-alone or network environments. Generally, program modules include routines, programs, objects, components, and data structures, etc. that perform particular tasks or implement particular abstract data types. Computing device-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the embodiments herein may be applied to each individual user where each user may individually deploy such a system. This enables each user to utilize the benefits of the embodiments herein even if anyone of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A vertical axis wind turbine method to convert air movement into generation of power, comprising:
capturing the air movement to generate the power with three or more turbine blades in an upper section of the turbine and a matching number of three or more turbine blades in a lower section of the turbine aligned with the three or more blades in the upper section;
transmitting torque from each blade in the upper section of the turbine with both an upper section top blade arm and an upper section bottom blade arm to an upper section rotating shaft;
transmitting a stress maxima to a center of each turbine blade in the upper section turbine by connecting each turbine blade in the upper section turbine 1) to the upper section top blade arm with an upper section top moment-free connector and 2) to the upper section bottom blade arm with an upper section bottom moment-free connector, where the top and bottom moment-free connector in the upper section are flexible at a connection point of that moment-free connector to its turbine blade in order to transmit the stress maxima to the center of each turbine blade where that turbine blade is at its strongest structurally;
transmitting torque from each turbine blade in a lower section of the turbine with both a lower section top blade arm and a lower section bottom blade arm to a lower section of the rotating shaft, which is bolted together with the upper section of the rotating shaft to form a unitary rotating shaft with multiple sections bolted together; and
transmitting a lower section stress maxima to a center of each turbine blade in the lower section of the turbine by connecting each turbine blade in the lower section 1) to the lower section top blade arm with a lower section top moment-free connector and 2) to the lower section bottom blade arm with a lower section bottom moment-free connector, where the top and bottom moment-free connector in the lower section are flexible at a connection point of that moment-free connector to its turbine blade in order to transmit the stress maxima to the center of each turbine blade where that turbine blade is at its strongest structurally.

2. The method of claim 1, further comprising:
supporting the rotating shaft with a fixed shaft; and
aligning vertically the fixed shaft with a tripod base in which the rotating shaft passes through a center of the tripod base, and
wherein the lower section top blade arm and the upper section bottom blade are combined into one blade arm and the lower section top moment-free connector and the upper section bottom moment-free connector are combined into one moment-free connector.

3. The method of claim 1, further comprising:
operating a row of vertical axis wind turbines a set distance upwind of a row of horizontal axis wind turbines in order to increase an amount of air flow that enters the horizontal axis wind turbines, which then produces more energy than it would have without the row of vertical axis wind turbines upwind.

4. A vertical axis wind turbine module, comprising:
a set of two or more turbine blades to capture air movement to generate power, wherein the set of two or more turbine blades includes a first turbine blade, a second turbine blade, and a third turbine blade;
a blade arm connected the first turbine blade to hold the first turbine blade parallel to a rotating shaft, wherein the rotating shaft couples into a rotor of an electrical power generator and the blade arm is configured to transmit torque from the first turbine blade to the rotating shaft to drive the rotor of the electrical power generator; and
a set of moment-free connectors, where a first moment-free connector connects to the first turbine blade to the blade arm to transmit a stress maxima to a structural strongpoint of the first turbine blade away from a connection point of the first moment-free connector to a center of the first turbine blade where the first turbine blade is at its strongest structurally.

5. The vertical axis wind turbine module of claim 4, wherein the blade arm includes an upper blade arm holding an upper portion of the first turbine blade and the first moment-free connector includes an upper moment-free connector connecting the upper blade arm to the upper portion of the first turbine blade.

6. The vertical axis wind turbine module of claim 5, further includes:
a lower blade arm to hold a lower portion of the first turbine blade; and
a lower moment-free connector connecting the lower portion of the first turbine blade to the lower blade so that the stress maxima is located on the first turbine blade away from the lower moment-free connector.

7. The vertical axis wind turbine module of claim 4, wherein the turbine blade is made of 1) aluminum or 2) an aluminum alloy, and the first moment-free connection is made of a metal material, and a separation layer is made of a polymer compression gasket and the separation layer exists between the moment-free connection and the turbine blade to eliminate fatigue and any potential corrosive effects between two different metals in contact.

8. The vertical axis wind turbine module of claim 4, wherein the rotating shaft includes multiple sections bolted together and the multiple sections shaft are machined to have tight tolerances for a straightness of the sections of the shaft and aligned by the bolted connection points between the rotating sections of the shaft.

9. The vertical axis wind turbine module of claim 4, wherein the first moment-free connector includes:
a blade arm connector coupled to the blade arm;
a blade end connector coupled to the first turbine blade; and
a blade end fairing to increase hinge aerodynamics.

10. The vertical axis wind turbine module of claim 4, wherein the first moment-free connector is a clamp shaped for 1) expansion and 2) compression or 3) both, of the first turbine blade, wherein the clamp is a steel clamp molded to fit the exact geometric shape of an aero foil of the first turbine blade.

11. The vertical axis wind turbine module of claim 4, wherein the turbine has at least an upper level and a lower level and each of these has its own set of two or more turbine blades, wherein each level with its own set of two or more blades, wherein the multiple levels of turbine blades are vertically aligned with one another rather than being vertically offset with respect to one another.

12. The vertical axis wind turbine module of claim 4, further comprises:
wherein the vertical axis wind turbine has a multiple support leg base for support stability upon which the turbine blades, blade arms and shaft rotate on, where the main shaft fits through a center of the tripod base in order to give a very solid and stable form/base to the vertical axis wind turbine, where the multiple support leg base is mounted on to a level concrete platform in order to allow the vertical axis wind turbine to withstand and operate in winds up to 50 meters per second (m/s).

13. The vertical axis wind turbine module of claim 4, where the placement of the next array of vertical axis wind turbines downwind can be closer than ten rotor diameters because a coupled vortex effect of closely placed turbines of various solidities creates less downwind wake and faster near ground wind speeds than vertical axis wind turbines not placed as closely as the coupled vortex effect allows.

14. A vertical axis wind turbine, comprising:
a vertical axis wind turbine module having a first turbine blade connected to a first blade arm by a first moment-free connector transmitting a first stress maxima to a first structural strongpoint at a first turbine blade center;
a rotating shaft acting as a vertical axis of the vertical axis wind turbine module connected to receive torque from the first blade arm of the first vertical axis wind turbine module;
a turbine base to support the rotating shaft; and
an electrical power generator with a rotor driven by the rotating shaft to generate power.

15. The vertical axis wind turbine of claim 14, wherein the vertical axis wind turbine module further comprises:
a second turbine blade connected to a second blade arm by a second moment-free connector so that a second stress maxima is located on a second turbine blade center; and
a third turbine blade connected to a third blade arm by a third moment-free connector so that a third stress maxima is located on a third turbine blade center.

16. The vertical axis wind turbine of claim 14, wherein the rotating shaft comprises:
an upper rotating shaft section; and
a lower rotating shaft section coupled to the upper rotating shaft section.

17. The vertical axis wind turbine of claim 14, wherein a lower flange of the upper rotating shaft section is bolted to an upper flange of the lower rotating shaft section, and wherein the vertical axis wind turbine module is an upper vertical axis wind turbine module coupled to the upper rotating shaft section.

18. The vertical axis wind turbine of claim 16, further comprising:
a lower vertical axis wind turbine module coupled to the lower rotating shaft section.

19. The vertical axis wind turbine of claim 17, wherein the upper vertical axis wind turbine module is offset from the lower vertical axis wind turbine module, wherein the upper vertical axis wind turbine module is aligned with the lower vertical axis wind turbine module.

20. The vertical axis wind turbine of claim 14, wherein the turbine base comprises:
a fixed shaft to support the rotating shaft;
a tripod to vertically align the fixed shaft; and
a concrete foundation block to level the tripod.
